(19) United States
(12) Patent Application Publication
(10) Pub. No.: US 2003/0041432 A1
(43) Pub. Date: Mar. 6, 2003

(54) Bearing cup insertion tool

(76) Inventor: Frederick L. Heflin, Evington, VA (US)

Correspondence Address: KIMBERLY A CHASTEEN, WILLIAMS MULLEN CLARK & DOBBINS, ONE IOD OYSTER POINT ROAD, SUITE 210, NEWPORT NEWS, VA, 23602

(21) Appl. No.: 09/938,192

(22) Filed: Aug. 23, 2001

(51) Int. Cl. B23P 19/04

(52) U.S. Cl. 29/263

(57) ABSTRACT

This invention is a specialized tool to insert bearing cups into wheel hubs on vehicles. Typically, conventional means to insert bearing cups would be to use a device that includes striking the bearing cup with a hammer or punch. Such an insertion could damage the wheel hub or the bearing cup. Other means exist utilizing complex, hard to use, mechanical devices. This invention is a simple, non-impact type bearing cup insertion tool utilizing a rod and specialized insertion elements. The insertion elements work along the rod to controllably force the bearing cups into the wheel hub safely without impacting the bearing cups.

### RELATED APPLICATION

The present invention is related to the invention described in co-owned, co-pending patent application Ser. No. 09/413,085 filed on Oct. 6, 1999.

### BACKGROUND OF THE INVENTION

1. Field of the Invention

The present invention relates generally to an apparatus for inserting a bearing cup and, more particularly, to an apparatus for inserting bearing cups for bearings in wheel hubs of vehicles.

2. Description of the Related Art

As anyone who performs a lot of mechanical work will attest, nothing beats having the proper tool for a job. The proper tool can save time, save money, produce a higher quality job, reduce damage to equipment, and provide for the increased safety of the worker. Each field of mechanical work has its own type of specialty tools, each performing a specialized task. One field where there has been a need for such a specialized tool is in the repair of wheel bearings for vehicles, particularly the inserting of bearing cups. Bearing cups used for bearings often have to be replaced on a regular basis with such units. In the past one method of seating such bearing cups has included hitting them with a hammer or punch. Needless to say, such a method can easily damage the cup or the hub in which it is mounted. Such damage can be extremely costly. Additionally, the action of hitting them with a hammer or punch puts the worker at increased risk of physical injury, should the bearing cup fly out of the hub.

In the related art, there exist many patents for various devices and methods for installing bearings, seals, gears, impellers, bushings and sprockets. Only two patents were found that even discuss bearing cups for wheel bearings and the like. U.S. Pat. No. 4,505,689 issued to Mazziotti discloses a mounting for a bearing cup of a universal joint but does not disclose a tool for inserting a bearing cup.

U.S. Pat. No. 4,429,447 issued to Davis discloses a bearing cup installation tool. The device in Davis appears to be of a universal design to allow the installation of bearing cups of varying diameters in vehicles of all sorts. Further, the Davis design has a cross head with three pairs of radially extending arms for engaging an outer end of the bearing cup and a driving handle, whereby driving force imparted by a hammer, struck against an end of the driving handle, drives the bearing cup into the opening.

The present invention differs from Davis in many respects. First of all, the present invention uses a design which presses the bearing cup into the bearing hub. This eliminates the need for a driving force from the use of a hammer or other instrument. Whenever a driving force delivered by impact is delivered, the potential for damaging the bearing cup or bearing hub is always present. The present invention eliminates this problem by allowing one to slowly and controllably press the bearing cup into the hub. The present invention also can accommodate bearing cups and hubs of varying diameters but it accomplishes this without requiring the use of a bulky and a mechanically complex expanding radial arm assembly.

Accordingly, there is a need for a less complicated device and method by which an individual can quickly and easily seat bearing cups for bearings in the wheel hubs of vehicles without risk of damage or injury. The development of the Bearing Cup Insertion Tool fulfills this need.

A search of the prior art did not disclose any patents that read directly on the claims of the instant invention; however, the following references were considered related:

| U.S. Pat. No. | Inventor | Issue Date |
|---|---|---|
| 4,339,865 | Shultz | Jul. 20, 1982 |
| 2,775,025 | Williams | Dec. 25, 1956 |
| 5,836,078 | Aiken et al. | Nov. 17, 1998 |
| 4,646,412 | Eade | Mar. 3, 1987 |
| 4,505,689 | Mazzioti | Mar. 19, 1985 |
| 4,429,447 | Davis | Feb. 7, 1984 |
| 4,173,813 | Stockinger | Nov. 13, 1979 |
| 3,942,234 | Kepler | Mar. 9, 1976 |

### SUMMARY OF THE INVENTION

A tool for inserting bearing cups into a wheel hub of a vehicle is provided which includes a rod and at least two insertion elements. The insertion elements can be installed on the rod, for example, through a threaded aperture in the center of the insertion element which is mated with threads on the outer surface of the rod. Alternatively, a threaded nut can be installed in an aperture in the center of the insertion element and the threaded nut can then mate with threads on the outside of the rod. Each insertion element includes a tapered side surface on at least a portion of the insertion element. The tool further includes means for moving the insertion elements along the rod towards each other during the insertion process. For example, if a threaded rod is used, the threads may be in opposite directions at the opposite ends of the rod so that the insertion elements move in opposite directions depending on which way the rod is rotated or pressed by mechanical, electrical or hydraulic means or other method as appropriate. A means for removing the rod and insertion elements is also provided. If a threaded rod is used, this removal may be accomplished by rotating the rod in the opposite direction once the bearing cups are inserted in the wheel hub. If desired, the rod can be of one diameter at one end and of a different diameter at the other end to ensure proper installation of the insertion elements. A hydraulic cylinder can be used as the rod if appropriate.

It is therefore an object of the present invention to provide an improved bearing cup insertion tool.

It is another object the present invention to provide a bearing cup insertion tool that seats bearing cups in hubs of vehicles.

It is yet another object of the present invention to eliminate the use of a hammer to install bearing cups.

It is yet another object of the present invention to provide a bearing cup insertion tool which eliminates or reduces the risk of injury.

It is still yet another object of the present invention to protect bearing surfaces and bearing cup surfaces while installing bearing cups.

It is a feature of the present invention to allow for quick resets after use.

It is yet still another object of the present invention to be quick, easy to use.

Briefly described according to one embodiment of the present invention, the Bearing Cup Insertion Tool, as its name implies, is a specialized tool to install bearing cups on vehicle wheel hubs. The tool accomplishes this task with a minimum of effort and without driving the bearing cups with a hammer, which can damage them beyond repair. A rod is inserted through the hub and the bearing cups. Next, specially designed bearing cup insertion elements are added to each end which are then driven towards each other. This movement in turn presses the bearing cups into the recesses in the hub.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a view of the outer surface of the insertion element of a Bearing Cup Insertion Tool, according to the preferred embodiment of the present invention;

FIG. 2 is a view of the inner surface of the insertion element of a Bearing Cup Insertion Tool, according to the preferred embodiment of the present invention;

FIG. 3 is a side view of the insertion element of a Bearing Cup Insertion Tool, according to the preferred embodiment of the present invention; and

FIGS. 4-5 are top views of the Bearing Cup Insertion Tool and its contemplated usage in the wheel hub of a vehicle, according to the preferred embodiment of the present invention.

### LIST OF REFERENCE NUMBERS

| | |
|---|---|
| 10 | insertion element |
| 10a | insertion element |
| 12 | aperture |
| 14 | nut |
| 14a | nut |
| 16 | tapered surface of insertion |
| | element |
| 16a | tapered surface of insertion |
| | element |
| 18 | lip portion of insertion element |
| 18a | lip portion of insertion element |
| 20 | rod |
| 22 | outer surface of bearing cup |
| 22a | outer surface of bearing cup |
| 24 | inner surface of bearing cup |
| 24a | inner surface of bearing cup |

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention.

1. Detailed Description of the Figures

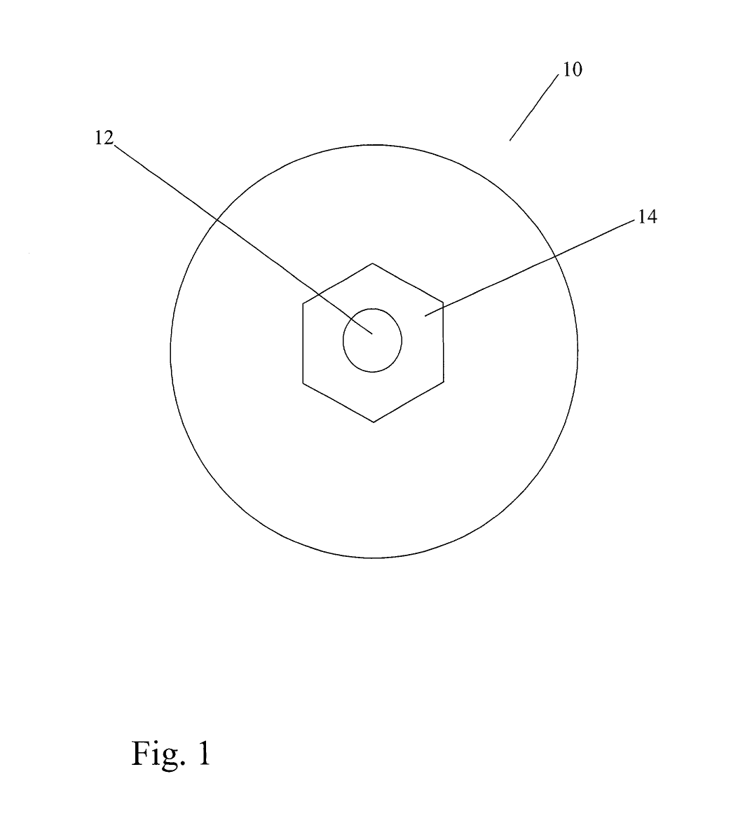

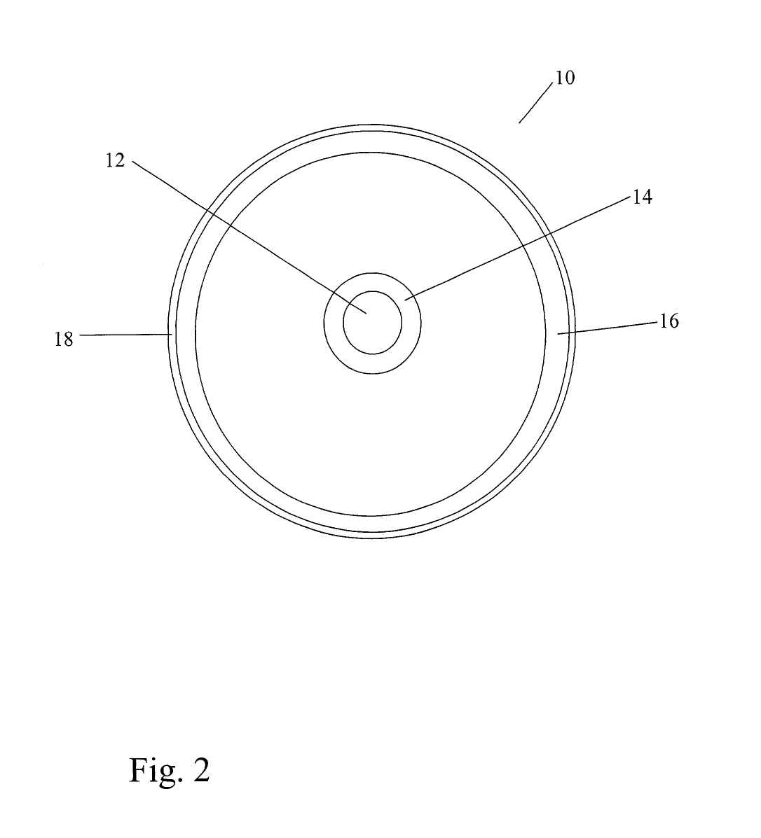

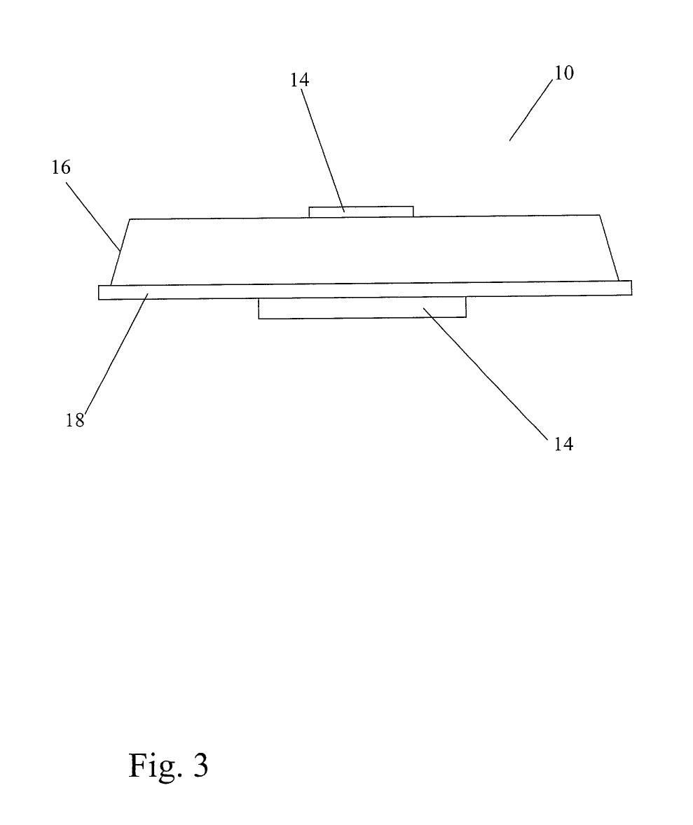

Referring now to FIG. 1, shown is a view of the outer surface of one of the insertion elements 10 of the Bearing Cup Insertion Tool. The insertion element 10 is composed of a flat, generally annular shaped disc with an aperture 12 in the center and is placed on one side of a wheel hub. A mirror image of the insertion element 10 is placed on the other side of the wheel hub. While the insertion element 10 is shown as generally circular, clearly alternative shapes are contemplated. In this particularly preferred embodiment, a hexagonally shaped nut 14 passes through the center aperture 12 of insertion element 10. In the preferred embodiment shown in the drawings, the nut 14 is threaded to allow a threaded connection with a rod 20. FIG. 2 shows the inner surface of the insertion element 10. FIG. 3 shows a side view of the insertion element 10. As can be seen, the side edges 16 of the insertion element 10 are tapered and the insertion element includes a lip 18. Different sized insertion elements can be used for wheel hubs having different sized bearing cups.

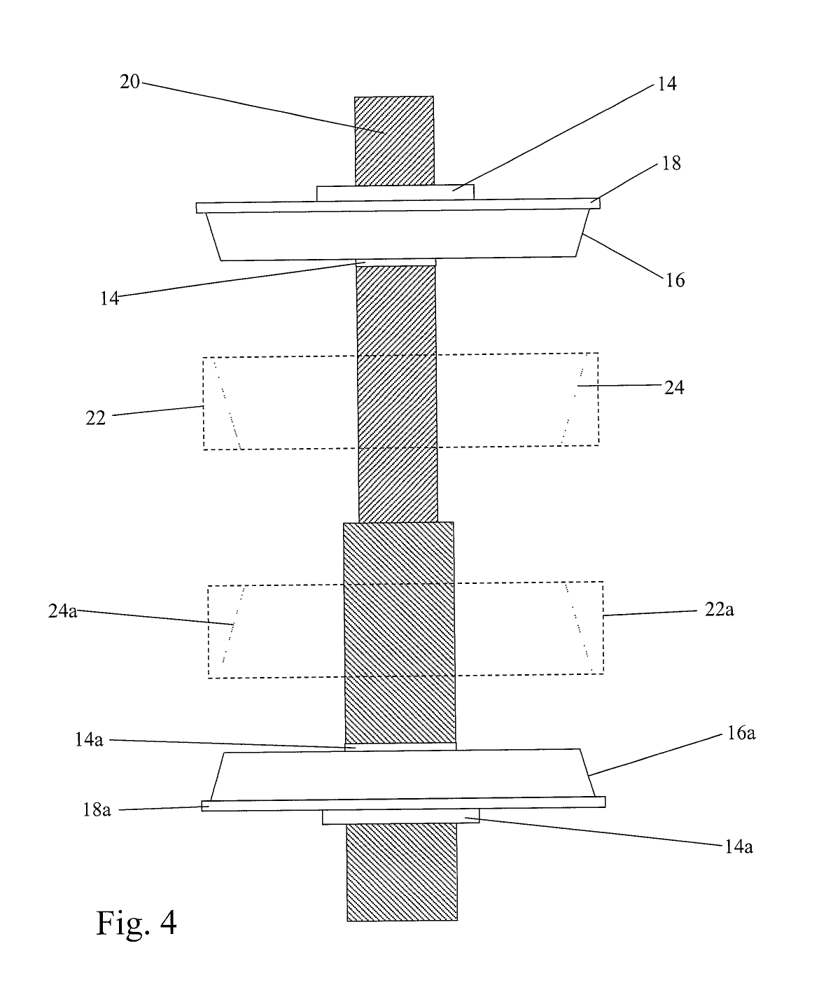

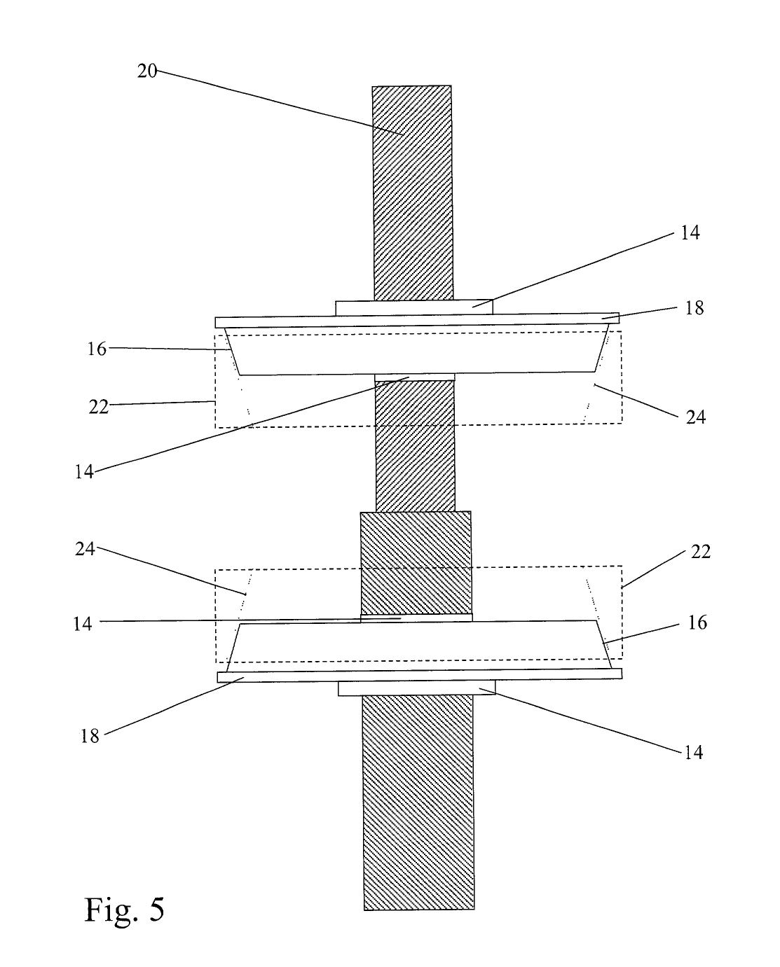

A rod 20 (shown in FIGS. 4-5 ) is generally cylindrical in shape. In the preferred embodiment shown in the drawings, the rod 20 is threaded. One end of the rod 20 may be of a larger diameter than the other end. This particularly preferred characteristic facilitates use of the insertion tool as the apertures 12 of the insertion elements 10 and 10a can be sized accordingly so that the tool can quickly and easily be constructed in the correct configuration for use. This construction ensures that the correct insertion element 10, 10a is placed on the correct end of the rod 20 such that the tapered side edges 16, 16a of the insertion elements 20, 20a are facing the correct way. The length of rod 20 depends on the width of the wheel hub which varies from manufacturer to manufacturer. Although there is no specific diameter of rod 20 required, it must be of large enough diameter to withstand the forces exerted on it while urging the bearing cups 22, 22a into the cavity of the wheel hub. It must not be of such a large diameter that it will not fit through the hollow center of the bearing cups 22 and 22a or the apertures of the insertion elements 10 and 10a.

Bearing cups 22, 22a are typically designed so that the side of the bearing cup 24, 24a designed to receive a bearing is of an outwardly tapered shape. The tapered surface 16, 16a of the insertion elements 10, 10a is sized to be just slightly larger than the inner diameter of the inner bearing cup 22, 22a and tapered inwardly so that it nearly mates with the tapered surface 24, 24a of the bearing cup 22, 22a. However, preferably, the tapered surface 16, 16a of the insertion element 10, 10a is tapered more outwardly than the tapered surface of the bearing cup 22, 22a so that the surfaces do not fully mate.

2. Operation of the Preferred Embodiment

FIGS. 4-5 show the insertion tool in use. To use the present invention, one selects the appropriate sized inner and outer insertion elements 10, 10a and threaded rod 20. In FIG. 4, two generally mirror image insertion elements 10 and 10a are threaded onto threaded rod 20 with the insertion elements on opposite sides of the wheel hub (not shown) and, more particularly, on opposite sides of the bearing cups 22 and 22a to be inserted. The threaded rod 20 is then manipulated mechanically, electrically or hydraulically to force the insertion elements 10 and 10a towards the bearing cups 22 and 22a to be inserted. For illustration purposes, the outside edges of the bearing cups 20 and 20a are shown by dashed lines while the inside surfaces are shown by dotted lines. FIG. 5 shows that as the insertion elements 10 and 10a are driven towards each other by the rod 20, the tapered edges 16, 16a come into contact with the tapered edges 24, 24a of the bearing cups 22, 22a, thus forcing the bearing cups 22, 22a into the wheel hub.

Once the bearing cups 22, 22a have been driven far enough to be seated in the wheel hub, the insertion elements 10 and 10a are then moved away from each other for removal. If a threaded rod 20 is used as shown in the drawings, this can be accomplished by reversing the rotation of the rod 20.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A tool for inserting bearing cups into the wheel hub of a vehicle, comprising:
a rod having an outer surface and first and second ends;
at least two insertion elements capable of being installed on opposite ends of the rod, each insertion element having:
an inner surface,
an outer surface,
an aperture formed in the center, the aperture having an inner surface, and p2 a tapered side surface; and
a means for decreasing the distance between the insertion elements installed on the rod.

2. A tool for inserting bearing cups into the wheel hub of a vehicle as described in claim 1, wherein the rod is threaded.

3. A tool for inserting bearing cups into the wheel hub of a vehicle as described in claim 1, wherein the rod is threaded in one direction at the first end and threaded in the opposite direction at the second end.

4. A tool for inserting bearing cups into the wheel hub of a vehicle as described in claim 1, wherein the rod is of a first diameter at the first end and of a second diameter at the second end, wherein the first and second diameters are not equal.

5. A tool for inserting bearing cups into the wheel hub of a vehicle as described in claim 1, wherein the rod is a hydraulic cylinder.

6. A tool for inserting bearing cups into the wheel hub of a vehicle as described in claim 1, wherein the insertion elements further include a nut installed in the aperture.

7. A tool for inserting bearing cups into the wheel hub of a vehicle as described in claim 6, wherein the nut installed in the aperture is threaded.

8. A tool for inserting bearing cups into the wheel hub of a vehicle as described in claim 1, wherein the means for decreasing the distance between the insertion elements installed on the rod comprises:
the first end of the rod being threaded in one direction and the second end of the rod being threaded in the opposite direction;
the inner surface of the apertures being threaded; and
a means for rotating the rod.

9. A tool for inserting bearing cups into the wheel hub of a vehicle as described in claim 8, wherein the means for rotating the rod is a method selected from the group consisting of mechanical, electrical or hydraulic.

10. A tool for inserting bearing cups into the wheel hub of a vehicle, comprising:
a rod having an outer surface and first and second ends, wherein the rod is threaded in one direction at the first end and threaded in an opposite direction at the second end;
at least two insertion elements capable of being installed on opposite ends of the rod, each insertion element having:
an inner surface,
an outer surface,
an aperture formed in the center, the aperture having a threaded inner surface, and
a tapered side surface; and
a means for rotating the rod such that the distance between the insertion elements installed on the rod is decreased.

11. A tool for inserting bearing cups into the wheel hub of a vehicle as described in claim 10, further comprising:
a means for rotating the rod such that the distance between the insertion elements installed on the rod is increased.

12. A tool for inserting bearing cups into the wheel hub of a vehicle, comprising:
a rod having an outer surface and first and second ends, wherein the rod is threaded in one direction at the first end and threaded in an opposite direction at the second end;
at least two insertion elements capable of being installed on opposite ends of the rod, each insertion element having:
an inner surface,
an outer surface,
an aperture formed in the center, the aperture having an inner surface,
a threaded nut installed in the aperture, and
a tapered side surface;
a means for rotating the rod such that the distance between the insertion elements installed on the rod is decreased.

13. A tool for inserting bearing cups into the wheel hub of a vehicle as described in claim 12, further comprising:
a means for rotating the rod such that the distance between the insertion elements installed on the rod is increased.
